(19) United States
(12) Patent Application Publication
(10) Pub. No.: US 2008/0137655 A1
(43) Pub. Date: Jun. 12, 2008

(54) System and method of resource management and call admission control in access network

(75) Inventors: Sun Me Kim, Daejeon-city (KR); Kyoung-Soon Kang, Daejeon-city (KR); Dong-Yong Kwak, Daejeon-city (KR); Hae Sook Kim, Daejeon-city (KR); Jong Rak Kim, Daejeon-city (KR); Jeong-Jong Lee, Daejoen-city (KR); Wang Bong Lee, Daejoen-city (KR); Sang Kwon Shin, Daejoen-city (KR)

Correspondence Address: BLAKELY SOKOLOFF TAYLOR & ZAFMAN, 1279 OAKMEAD PARKWAY, SUNNYVALE, CA, 94085-4040, US

(73) Assignee: Electronics and Telecommunications Research Institute

(21) Appl. No.: 11/980,169

(22) Filed: Oct. 30, 2007

(30) Foreign Application Priority Data
Dec. 8, 2006 (KR) 10-2006-00125048

(51) Int. Cl. H04L 12/56

(52) U.S. Cl. 370/389

(57) ABSTRACT

Provided is a method of resource management and call admission control in an access network in a hierarchical manner.

The method of resource management and call admission control in an access network includes: (a) collecting resource information on all of devices constituting the access network and hierarchically constructing the resource information on the access network; (b) when a user requests a connection to the access network, hierarchically extracting position information on the access network from the resource information and connecting the extracted position information to link information in the hierarchically constructed resource information; (c) when a user who succeeds in connecting requests call admission control for an IP communication service, determining an availability of the resources of the hierarchically constructed position information; and (d) when the availability is certified, allocating a band required to the IP communication service to the link information and a part of a margin band of a service class to which the user belongs to respond to the call admission control request.

### CROSS-REFERENCE TO RELATED PATENT APPLICATION

This application claims the benefit of Korean Patent Application No. 10-2006-00125048, filed on Dec. 8, 2006, in the Korean Intellectual Property Office, the disclosure of which is incorporated herein in its entirety by reference.

### BACKGROUND OF THE INVENTION

1. Field of the Invention

The present invention relates to a method and system for resource management and call admission control in an access network, and more particularly, to a method and system for resource management and call admission control in an access network in a hierarchical manner.

2. Description of the Related Art

A demand for multimedia Internet protocol (IP) communication services in an IP packet network having substantially the same quality as that in a circuit network such as a voice over Internet protocol (VoIP), a multimedia over Internet protocol (MMoIP), a video on demand (VoD), and an Internet protocol television (IPTV) increases. In order to guarantee quality of the multimedia IP communication services, it is necessary to guarantee quality of service (QoS) in the IP packet network of an end-to-end section.

However, in an access network including from subscriber terminals to multilevel subscriber concentrators, due to a diversity of devices constructed for the access network, the excessive number of the devices, and a wide range of provided functions, consistent network resource management and service control are impossible. Therefore, control of the QoS in the access network section having a highest traffic concentration ratio is difficult.

A conventional method associated with a method of managing a control layer of the access network provides a function of managing resources of a physical link or network resources based on a multi protocol label switching label-switched path (MPLS LSP) and a function of IP communication service call admission control for the managed resources, only in a region from a metro network section to another metro network section, due to complexity of the access network.

However, the IP communication service has to allocate resources to the service and guarantee quality in the end-to-end section of the network such as a section from a calling subscriber terminal to a called subscriber terminal (two-way) or a section from a calling subscriber terminal to a service providing server (one-way). However, in the conventional management method, as described above, a quality guarantee only for a metro-to-metro section that is in the middle of the end-to-end section is possible, so that guarantees of resource allocation and quality for an end-to-metro section that is a subscriber access network section having a highest traffic concentration are impossible.

### SUMMARY OF THE INVENTION

According to an aspect of the present invention, there is provided a method of resource management and call admission control in an access network including: (a) collecting resource information on all of devices constituting the access network and hierarchically constructing the resource information on the access network; (b) when a user requests a connection to the access network, hierarchically extracting position information on the access network from the resource information and connecting the extracted position information to link information in the hierarchically constructed resource information; (c) when a user who succeeds in connecting requests call admission control for an IP communication service, determining an availability of the resources of the hierarchically constructed position information; and (d) when the availability is certified, allocating a band required to the IP communication service to the link information and a part of a margin band of a service class to which the user belongs to respond to the call admission control request.

According to another aspect of the present invention, there is provided a system for resource management and call admission control in an access network, the system including: a resource information construction unit collecting resource information on all of devices constituting the access network and hierarchically constructing the resource information on the access network; a position information extractor which receives a request of a connection to the access network from a user and hierarchically extracts position information on the access network from the resource information; a connection unit connecting the extracted position information to link information in the hierarchically constructed resource information; a resource availability determining unit determining an availability of the resources of the hierarchically constructed position information when a user who succeeds in connecting requests call admission control for an IP (Internet protocol) communication service; and a band allocation unit allocating a band required to the IP communication service to the link information and a part of a margin band of a service class to which the user belongs, when the availability is certified.

### BRIEF DESCRIPTION OF THE DRAWINGS

The above and other features and advantages of the present invention will become more apparent by describing in detail exemplary embodiments thereof with reference to the attached drawings in which:

FIG. 1 is a view showing a structure of a network applying hierarchical network resource management and call admission control according to an embodiment of the present invention;

FIG. 2 is a view showing methods of collecting and managing resource information on an access network according to an embodiment of the present invention;

FIG. 3A is a view showing operations of applying hierarchical resource information on an access network constructed in an access network control server, in a process of call admission control for an access network connection request and an Internet protocol (IP) communication service attempt from a user according to an embodiment of the present invention;

FIG. 3B is a view showing an example of tables in which resource information needed to manage and control hierarchical resources is hierarchically constructed according to an embodiment of the present invention; and

FIGS. 3C and 3D are views showing operations of call admission control for an IP communication service for a user by collecting/constructing resource information on an access network, constructing hierarchical resource information on an access network connection point connected to the user, and using the constructed hierarchical resource information according to an embodiment of the present invention.

### DETAILED DESCRIPTION OF THE INVENTION

The present invention provides a method and system for resource management and call admission control in an access network capable of guaranteeing quality of an Internet protocol (IP) communication service over an entire end-to-end section.

Abbreviations used for the description of the present invention are as follows.

CAC: call admission control

DSL: digital subscriber line

DSLAM: digital subscriber line access multiplexer

FES: fast Ethernet switch

IP communication service: a multimedia service performed by receiving resources of a service allocated by CAC from a network and by guaranteeing quality

NT: network termination

RG: residential gateway

According to the core of the technical solution of the present invention, physical and logical resource information on an access network constructed with various and the excessive number of devices is hierarchically managed, and a call admission control method of extracting position information (path information) on a network connected to a user and hierarchically managing the extracted for multilevel access network resources is used, so that it is possible to effectively and consistently control the network and guarantee quality of a multimedia IP communication service in end-to-end sections.

Hereinafter, exemplary embodiments of the present invention will be described in detail with reference to the attached drawings. Like reference numerals in the drawings denote like elements.

In order to provide a multimedia service in an IP packet network having substantially the same quality as that in a circuit network, quality of service in the access network which is excluded from a quality of service (QoS) guarantee range has to be guaranteed. Accordingly, the need of an access network control server becomes an issue. In a hierarchical resource management method according to an embodiment of the present invention, a control model that is applicable to the network can be obtained.

For the access network resource hierarchical management and the call admission control function for the hierarchically managed resources according to the embodiment of the present invention, collecting information on resources used for the access network, hierarchically constructing the information on the resources, obtaining a network connection position of a user and information on the position, and detailed functions of the call admission control for the hierarchical resources have to be performed.

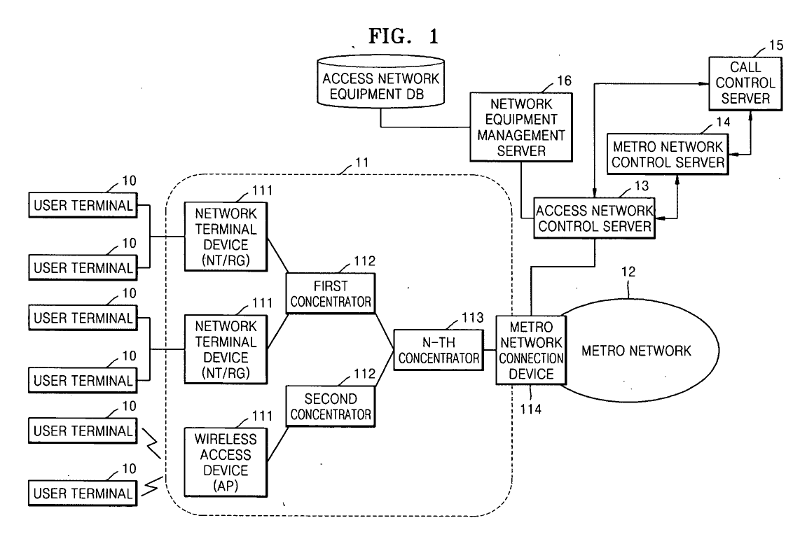

FIG. 1 is a view showing a structure of a network applying hierarchical network resource management and call admission control according to an embodiment of the present invention;

An IP communication service user connects to an access network 11 through a user terminal 10. The access network 11 has a function of transmitting subscriber traffic from a subscriber to a metro network connection device 114, and more specifically, the subscriber traffic (packet) is transmitted from a network terminal device NT/RG or an access point (AP) 111 which can be implemented as a modem or a home gateway as a starting point through first to n-th concentrators 112 and 113 such as a DSLAM or a FES to the metro network connection device 114.

The metro network connection device 114 transmits the packet to a metro network 12 so as to route the packet along a right path. The access network 11 ranges widely and has a function of packet management. The access network 11 mainly performs layer 2 packet switching and performs layer 3 IP communication through the network connection device 114.

An access network control server 13 processes access authentication for a subscriber, determines a network policy applied to the subscriber, performs the resource management and the service control for the access network 11, and interacts with the metro network control server 14 in order to control and manage the access network 11.

An IP communication service attempted by the user terminal 10 is controlled by a call control server 15. The call control server 15 interacts with the metro network control server 14 and the access network control server 13 in order to confirm an availability of the resources for a corresponding called/calling metro network and access network by analyzing a signaling packet and to control resource allocation/cancellation. In a network having a non-large scale, the call control server 15 may directly interact with the access network control server 13 without the metro network control server 14.

As another management server, there is a network equipment management server 16 for constructing/managing information on the devices in the access network 11 and transmission equipments and including an access network installation database (DB). The information on network equipments addition/deletion and transmission path change is managed in the network installation management server 16.

Objects managed by the access network control server 13 in order to guarantee and manage quality of the IP communication service in the access network 11 are as follows.

In a call admission control operation performed by the access network 11, objects of which availability of resources is specified are the network connection device 114, the concentrators 112 and 113, network terminal device 111, upward and downward connection links therebetween, and the effectiveness of service class resources allocated to each link.

Service classes are classified into N degrees (service class 1 to service class N) according to a policy of a provider. A band of the physical link is divided to be managed according to characteristics of each service and a demand of a user, so that a maximum service benefit can be created. Therefore, the objects of which resources are managed by the access network control server 13 are equipments, links, and service classes in the links. In addition, a physical construction and status is managed, and the links and service classes manage a maximum band and an effective band in upward and downward directions.

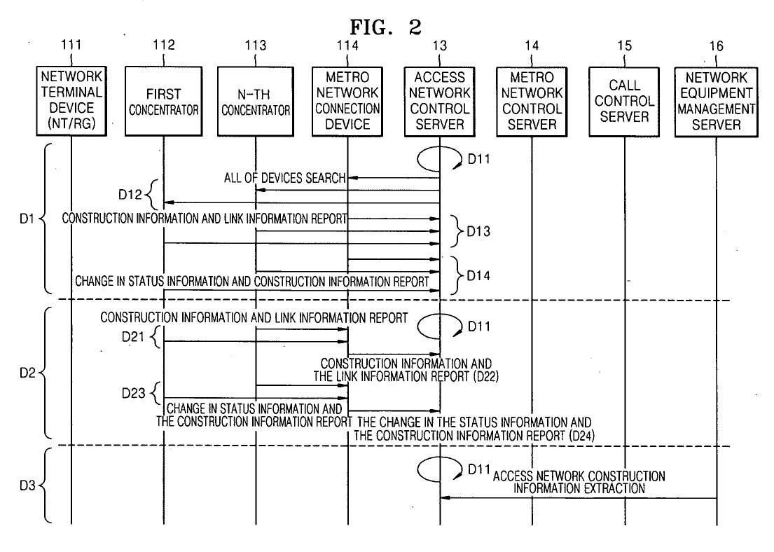

FIG. 2 is a view showing three methods of collecting and managing resource information on the access network 11.

In a first method D1 of collecting and managing resource information on the access network 11, the access network control server 13 connects to all of the devices constituting the access network 11 by using a management protocol such as a simple network management protocol (SNMP) in order to collect construction information, link information, and status information on the all of the devices.

More specifically, when the access network control server 13 is started (operation D11), the access network control server 13 searches for all of the devices constituting the access network 11 managed by the access network control server 13 (operation D12) and collects the construction information, the link information, and the status information on the all of the devices (operation D13) in order to hierarchically construct the resource information on the access network 11. When the all of the devices constituting the access network 11 change their information, the devices directly report the changed information to the access network control server 13 (operation D14).

In a second method D2 of collecting and managing the resource information on the access network 11, the metro network connection device 114 collects construction information, link information, and status information on the concentrators 112 and 113 from the concentrators 112 and 113 (operation D21) and transmits the collected information to the access network control server 13 (operation D22). When the concentrators 112 and 113 are restarted or change their information, the changed information is transmitted through the network connection device 114 to the access network control server 13 (operations D23 and D24).

In a third method D3 of collecting and managing the resource information on the access network 11, the access network control server 13 interacts with the network equipment management server 16 to extract construction information or the like on the access network 11 managed by the access network control server 13 so as to hierarchically construct the resource information on the access network 11.

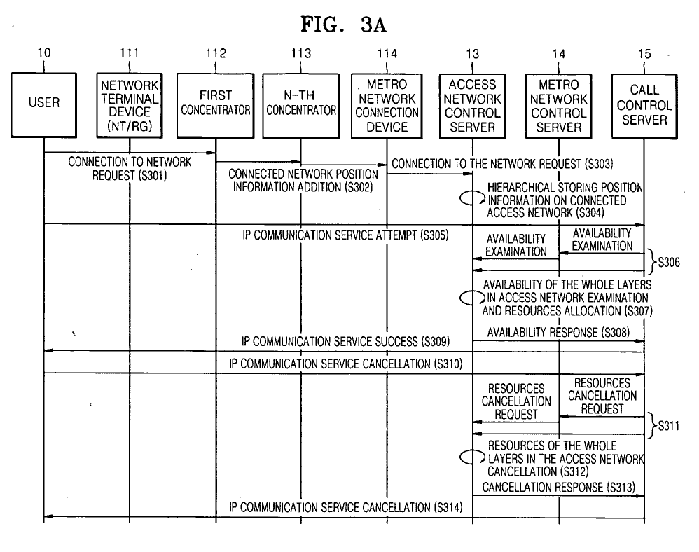

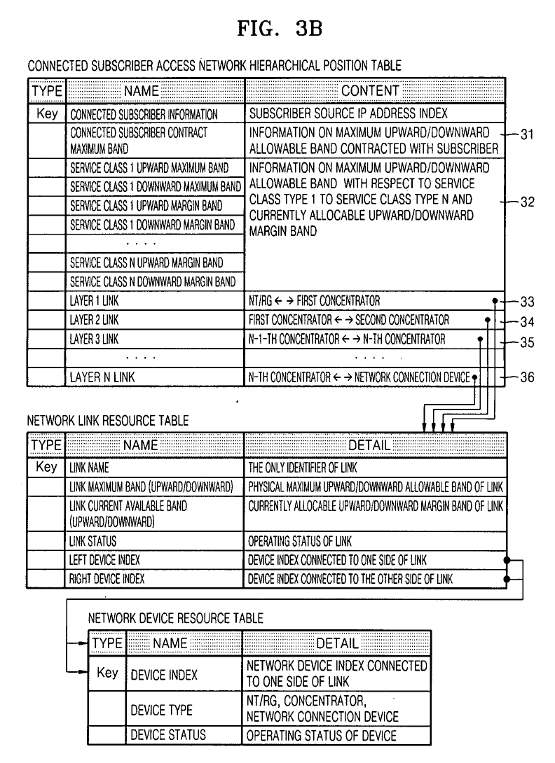

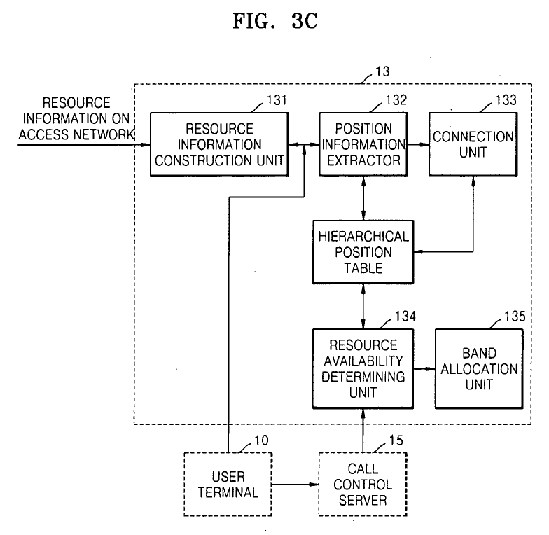

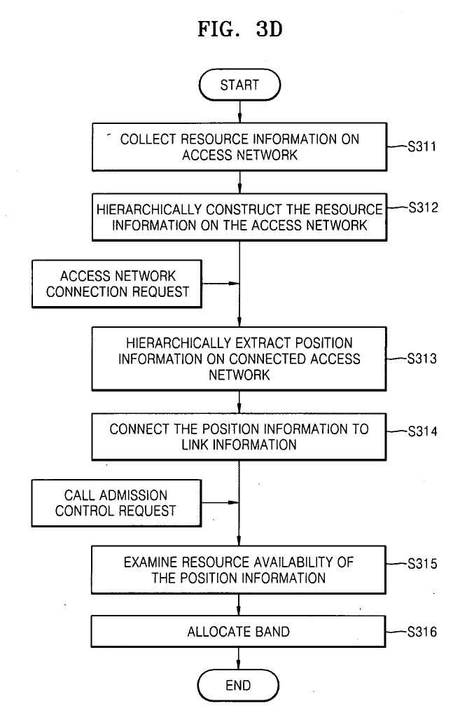

FIG. 3A is a view showing operations of applying hierarchical resource information on the access network 11 constructed in an access network control server 13, in a process of call admission control for an access network connection request and an Internet protocol (IP) communication service attempt from a user.

When the user 10 requests a connection to the access network 11 (operation S301), the first to n-th concentrators 112 and 113 add connection position information (path information) to the signaling packet of the user who attempts the connection and inform the metro network connection device 114 of an access network through which a connection is lastly attempted by the user, that is, position information on the connected access network (operation S302).

The metro network connection device 114 transmits the connection position information to the access network control server 13 through authentication to inform the access network control server 13 of the access network connection request (operation S303). The access network control server 13 hierarchically extracts position information on the access networks according to users and constructs a connected subscriber access network hierarchical position table shown in FIG. 3B (operation S304).

The connected subscriber access network hierarchical position table is, as shown in FIG. 3B, a table which is dynamically generated by using IP addresses or identifications (IDs) of the connected users as identifiers and represents a hierarchical relationship of link resources between the devices in connection paths, including from link resources 33 between the network terminal devices 111 connected to the users and the first concentrators 112, link resources 34 between the first concentrators 112 and second concentrators, to link resources 36 between the n-th concentrators 113 and the network connection device 114.

The connected subscriber access network hierarchical position table manages subscriber maximum band information 31 and information 32 on service class maximum upward/downward allowable band according to a type of a registered service and a margin band remained after allocation in order to use the aforementioned information as a decision basis of resource availability when call admission control is requested.

Each of the link resources fields 33 to 36 in the connected subscriber access network hierarchical position table is connected to a network link resource table including information on an identifier, an available upward/downward maximum band, a link status, and an upward/downward maximum band and margin band of the resources classified according to identifiers for two devices which are connected and the services classes in the links, according to links of the access network 11. In addition, a left device index and a right device index of the network link resource table are connected to a network device resource table for managing information on two devices which are connected with a link so as to include information on statuses of the connected devices along with the link status in order to manage the status of the resources.

The user 10 who succeeds in connecting to the access network 11 attempts to request an IP communication service of the call control server 15 (operation S305), and then the call control server 15 interacts with the access network control server 13 directly or through the metro network control server 12 in order to request the access network control server 13 to examine an availability of the resources of the access network 11.

The access network control server 13 which has requested perceives the position information (path information) on the access network 11 connected to the user 10 with reference to the information in the access network hierarchical position table, examines a status of a link of each layer and the availability of the resources according to the links and the service classes, subtracts resources (band) to be allocated to the IP communication service requested by the user 10 from a margin band (margin resources) according to the links and the service classes (operation S307), and transmits the call admission availability to the call control server 15 (operation S308). This means that the resources (band) to be allocated to the IP communication service are allocated to a part of the margin band according to the links and the service classes.

The call control server 15 informs the user 10 of the call admission that the IP communication service attempt succeeded (operation S309).

After the user 10 finishes the IP communication service, the user 10 requests the call admission server 15 to cancel the service (operation S310), the call control server 15 requests the access network control server 13 to cancel the allocated resources (operation S311), and the access network control server 13 cancels all of the resources allocated along connection paths of the access network 11 (operation S312) and responds to the call control server 15 for the cancellation (operation S313). The call control server 15 notifies the user 10 of a termination of the IP communication service for the user 10 (operation S314). Accordingly, the operations of applying the hierarchical resource information constructed in the access network control server 13 are completed.

FIGS. 3C and 3D are views showing operations of call admission control for an IP communication service for a user by collecting/constructing resource information on an access network, constructing hierarchical resource information on an access network connection point connected to the user, and using the constructed hierarchical resource information. FIGS. 3C and 3D show the whole operations described with reference to FIGS. 1 to 3A according to an embodiment of the present invention.

A resource information construction unit 131 of the access network control server 13, as described above with reference to FIG. 2, collects resource information on the access network 11 by directly communicating with the all of the devices constituting the access network 11 by using a management protocol such as a simple network management protocol (SNMP), communicating with the metro network connection device 114, or communicating with the network equipment management server 16 (operation S311) and hierarchically construct the resource information on the access network 11 by using a hierarchical relationship and correlation between the collected resource information (operation S312).

When the user requests a connection to the access network 11, a position information extractor 132 of the access network control server 13 hierarchically extracts position information (path information) on the access network 11 which has requested the connection from the constructed resource information on the access network 11 which has attempted the connection in order to construct the subscriber access network hierarchical position table shown in FIG. 3B (operation S313). The extracted position information is connected to link information in the resource information on the access network 11 which is hierarchically constructed by a connection unit 133 of the access network control server 13 (operation S314) in order to respond to the request of the connection to the access network 11.

When the call control server 15 receives a call admission control request for attempting the IP communication service from the user 10 who succeeds in connecting to the access network 11, the call control server 15 requests a resource availability determining unit 134 of the access network control server 13 to examine an availability of the hierarchically constructed resources with respect to the position information on the network connected to the user 10 in order to determine the availability (operation S315). When the availability is certified, a band allocation unit 135 of the access network control server 13 allocates a band required to the IP communication service to the margin band (operation S316) to respond to the call admission control request.

When the user 10 requests a termination of the IP communication service, a resource cancellation request is received to cancel the resources allocated to the user with respect to the hierarchical resources along the connection network path.

According to the operations described above, the access network 11 manages the resources consistently, so that service control and quality guarantees in an end-to-end section for the IP communication service for the user are possible.

Accordingly, by means of the resource management for the access network and the hierarchical resource management for the connection path of the connected user, the availability of the resources in the whole sections of the access network can be determined and the resource management is possible in the process of the call admission control for the IP communication service for the user. Therefore, the service control and guarantees of the quality of service in the end-to-end section are possible.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

While the present invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A system for resource management and call admission control in an access network, the system comprising:
a resource information construction unit collecting resource information on all of devices constituting the access network and hierarchically constructing the resource information on the access network;
a position information extractor which receives a request of a connection to the access network from a user and hierarchically extracts position information on the access network from the resource information;
a connection unit connecting the extracted position information to link information in the hierarchically constructed resource information;
a resource availability determining unit determining an availability of the resources of the hierarchically constructed position information when a user who succeeds in connecting requests call admission control for an IP (Internet protocol) communication service; and
a band allocation unit allocating a band required to the IP communication service to the link information and a part of a margin band of a service class to which the user belongs, when the availability is certified.

2. The system of claim 1, wherein, in order to construct the resource information, the resource information construction unit requests the all of the devices to provide resource information on the all of the devices, and the all of the devices provide the their resource information to the resource information construction unit in response to the providing request.

3. The system of claim 1, wherein, in order to construct the resource information, the resource information construction unit requests a metro network connection device which connects the access network to a metro network to collect resource information on the all of the devices, and the metro network connection device collects the resource information on the all of the devices from the all of the devices in response to the collecting request and transmits the collected resource information to the resource information construction unit.

4. The system of claim 1, wherein, in order to construct the resource information, the resource information construction unit requests a server for constructing/managing information on the all of the devices to provide the resource information on the all of the devices, and the server transmits the resource information to the resource information construction unit in response to the providing request.

5. A method of resource management and call admission control in an access network, the method comprising:
(a) collecting resource information on all of devices constituting the access network and hierarchically constructing the resource information on the access network;
(b) when a user requests a connection to the access network, hierarchically extracting position information on the access network from the resource information and connecting the extracted position information to link information in the hierarchically constructed resource information;
(c) when a user who succeeds in connecting requests call admission control for an IP communication service, determining an availability of the resources of the hierarchically constructed position information; and
(d) when the availability is certified, allocating a band required to the IP communication service to the link information and a part of a margin band of a service class to which the user belongs to respond to the call admission control request.
